(19) United States
(12) Patent Application Publication
(10) Pub. No.: US 2007/0171384 A1
(43) Pub. Date: Jul. 26, 2007

(54) Light guiding member, optical unit, and projector

(75) Inventor: Hirokazu Godo, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/651,650

(22) Filed: Jan. 9, 2007

(30) Foreign Application Priority Data
Jan. 24, 2006 (JP) 2006-014987

(51) Int. Cl. G03B 21/28

(52) U.S. Cl. 353/81; 385/146; 385/901; 362/26

(57) ABSTRACT

When guiding diffused light to an optical member that has optical surfaces parallel to the optical axis, illumination unevenness is efficiently uniformized at the light emitting surface without an overall increase in length. There is provided a light guiding member, wherein a plurality of tapered rod sections which abut along a central axis direction passing substantially through the centers of an incident end disposed on a light source side and an emitting end disposed on an optical member side are provided between the incident end and the emitting end, and each tapered rod section is shaped to widen gradually from the incident end side towards the emitting end side at a constant taper angle, and a taper angle of each tapered rod section is set smaller than a taper angle of the adjacent tapered rod section on the incident end side.

### BACKGROUND OF THE INVENTION

1. Field of the Invention

The present invention relates to a light guiding member, an optical unit, and a projector.

2. Description of Related Art

Conventionally, light guiding members are known which comprise a plurality of tapered rod sections abutting in the optical axis direction and guide diffused light emitted from a light source (for example Japanese Unexamined Patent Application, Publication No. 2005-70443 (referred to hereafter as reference document 1) and Japanese Unexamined Patent Application, Publication No. 2004-184692 (referred to hereafter as reference document 2)). In reference document 1, a light guiding member is disclosed which comprises two tapered rods, tapered at the same or opposing angles. Furthermore, also disclosed in reference documents 1 and 2 are light guiding members in which an untapered prismatic parallel rod section is provided at the light emitting end of one of the tapered rod sections. Moreover, also disclosed in reference document 2 is a light guiding member bonded to an optical member which has optical surfaces parallel to the optical axis, such as a triangular prism.

Furthermore, a rod integrator which comprises a plurality of parallel rod sections abutting in the optical axis direction is disclosed in Japanese Unexamined Patent Application, Publication No. 2004-325533 (referred to hereafter as reference document 3).

However, such light guiding members present a problem in that when a tapered rod section and a parallel rod section abut, or a tapered rod section abuts an optical member having optical surfaces parallel to the optical axis, reflection of the diffused light guided via the tapered rod section by the parallel rod or an optical surface of the optical member tends to cause so-called illumination unevenness in which the edges of the illumination area are brighter than other parts.

This problem is described with reference to FIG. 18 through FIG. 20.

FIG. 18 shows a situation in which diffused illumination light emitted by a light source 10 is guided by a tapered rod 20 to a transmissive LCD panel 40. FIG. 19 shows a case where a parallel rod 35 is interposed between the tapered rod 20 and the transmissive LCD panel 40, and FIG. 20 shows a detail of the portion P in FIG. 19.

In the situation shown in FIG. 18, there is no problem with unevenness in the illumination light guided to the transmissive LCD panel 40.

However, in situations such as that shown in FIG. 19, even if uniform light is emitted from the emitting end of the tapered rod 20, illumination unevenness tends to occur at the edges of the transmissive LCD panel 40 (see FIG. 20).

The cause of this illumination unevenness is that when the tapered rod 20 and the transmissive LCD panel 40 are placed in close proximity via the parallel rod 35, an angular difference develops between the angle of inclination of the side surfaces of the tapered rod 20 and the angle of inclination of the side surfaces of the parallel rod 35 which continue on from the side surfaces of the tapered rod 20, causing light that would have followed the original optical path before the introduction of the angular difference (the triangular portion enclosed by the dashed line in FIG. 20) to be superimposed at the edges of the transmissive LCD panel 40 (the crosshatched triangular portion in FIG. 20).

In reference document 3, a technique is disclosed in which the luminance distribution of the light-emitting surface is uniformized by elongating the rod integrator. However, elongating light guiding members such as the rod integrator or tapered rod is not a favorable solution as this increases the scale of the device and raises production costs.

### BRIEF SUMMARY OF THE INVENTION

The present invention takes into consideration the above circumstances, with an object of providing a light guiding member and optical unit capable of efficiently uniformizing illumination unevenness at the light emitting surface without an overall increase in length when guiding diffused light to an optical member that has optical surfaces parallel to the optical axis. Another object of the present invention is to provide a projector capable of efficiently uniformizing illumination unevenness at the light emitting surface, and projecting an image free of illumination unevenness.

A first aspect of the invention is a light guiding member which guides diffused light emitted from a light source to an optical member having optical surfaces parallel to the optical axis, wherein a plurality of tapered rod sections which abut along a central axis direction passing substantially through the centers of an incident end disposed on the light source side and an emitting end disposed on the optical member side are provided between the incident end and the emitting end, and each tapered rod section is shaped to widen gradually from the incident end side towards the emitting end side at a constant taper angle, and a taper angle of each tapered rod section is set smaller than a taper angle of the adjacent tapered rod section on the incident end side.

According to this aspect, the diffused light emitted by the light source is made incident from the incident end, and passes through the plurality of tapered rod sections in the process of being guided to the emitting end which connects to the optical member. The diffused light, having been reflected by the tapered surfaces of each tapered rod section while being guided, is made incident upon the optical member as light with uniform luminance distribution and improved directivity along the central axis.

In this case, the diffused light, while being guided from the incident end side of the light guiding member towards the emitting end side, passes through tapered rod sections that widen at successively smaller angles. Because the next tapered rod section that the diffused light enters after being emitted from the preceding tapered rod section also widens gradually, the diffused light is not reflected back sharply at the boundary of each tapered rod section, which suppresses an increase in light intensity unevenness.

Furthermore, when compared with a light guiding member of equivalent length which has a single taper angle connecting the incident end to the emitting end, the taper angle at the tapered rod section closest to the emitting end is sufficiently small to enhance the directivity of the diffused light emitted from the emitting end. Accordingly, the extent to which diffused light incident into an optical member having optical surfaces parallel to the optical axis reflects back sharply from the optical surfaces can be minimized, and light intensity unevenness can be reduced.

In the first aspect, the plurality of tapered rod sections may be bonded to each other.

By employing such a construction, when compared to a case in which the plurality of tapered rod sections with different taper angles are processed as a single component, processing can be simplified and production costs reduced.

In the first aspect, preferably the light guiding member comprises two tapered rod sections, such that a length along a central axis of a first tapered rod section disposed on an incident end side is shorter than a length along a central axis of a second tapered rod section disposed on an emitting end side.

By employing such a construction, light intensity unevenness can be more efficiently uniformized.

In the first aspect, surfaces constituting each tapered rod section may be flat surfaces.

By employing such a construction, processing of each surface can be simplified and production costs reduced. Furthermore, problems such as light leakage and reduced transmissivity between the plurality of tapered rod sections can be suppressed.

In addition, forming the plurality of tapered rod sections as a single component enables the light guiding member to be fixed in place more easily.

A second aspect of the invention is an optical unit comprising; an optical member having optical surfaces parallel to an optical axis, and a light guiding member which guides diffused light emitted from a light source to the optical member, wherein the light guiding member comprises a plurality of tapered rod sections abutting in an optical axis direction between an incident end disposed on the light source side and an emitting end disposed on the optical member side, and each tapered rod section is shaped to widen gradually from an incident end side towards an emitting end side at a constant taper angle, and a taper angle of each tapered rod section is set smaller than a taper angle of the adjacent tapered rod section on the incident end side.

According to this aspect, the diffused light, while being guided from the incident end side of the light guiding member towards the emitting end side, passes through tapered rod sections that widen at successively smaller angles. Because the next tapered rod section that the diffused light enters after being emitted from the preceding tapered rod section also widens gradually, the diffused light is not reflected back sharply at the boundary of each tapered rod section, which suppresses an increase in light intensity unevenness.

Furthermore, when compared with a light guiding member of equivalent length which has a single taper angle connecting the incident end to the emitting end, the taper angle at the tapered rod section closest to the emitting end is sufficiently small to enhance the directivity of the diffused light emitted from the emitting end. Accordingly, the extent to which diffused light incident into an optical member having optical surfaces parallel to the optical axis reflects back sharply from the optical surfaces can be minimized, and light intensity unevenness can be reduced.

In the second aspect, the plurality of tapered rod sections and the optical member may be bonded to each other.

By employing such a construction, when compared to a case in which the plurality of tapered rod sections with different taper angles are processed as a single component, processing can be simplified and production costs reduced.

Furthermore, in this aspect of the invention, the optical member may be any one of a triangular prism, a polarizing beam splitter, and a dichroic prism.

In the second aspect, preferably the light guiding member comprises two tapered rod sections, and a length along a central axis of a first tapered rod section disposed on an incident end side is shorter than a length along a central axis of a second tapered rod section disposed on an emitting end side.

By employing such a construction, light intensity unevenness can be more efficiently uniformized.

In the second aspect, the emitting end of the light guiding member may be approximately the same size and shape as the incident end of the optical member.

By employing such a construction, the diffused light guided through the light guiding member can be made incident onto the optical member in an efficient manner.

The emitting end of the light guiding member may also be smaller than the incident end of the optical member. By employing such a construction, light intensity unevenness can be more efficiently uniformized.

In the second aspect, surfaces constituting the light guiding member may be flat surfaces.

By employing such a construction, processing of each surface can be simplified and production costs reduced.

A third aspect of the invention is a projector comprising; any of the optical units described above, a light source which emits diffused light serving as illumination light, a modulation device which modulates an illumination light, which is a light emitted from an optical member of the optical unit onto which the illumination light from the light source is made incident, and a projection optical device which projects the illumination light modulated by the modulation device onto a screen.

According to this aspect, the diffused light emitted from the light source, in the process of passing through the optical unit, is transformed into illumination light with little light intensity unevenness and high directivity before being emitted from the optical member. The illumination light emitted from the optical member is modulated by the modulation device, and then projected onto the screen by the projection optical device. Accordingly, an image with little illumination unevenness can be obtained.

In the third aspect, in each tapered rod section, a ratio of a taper angle to a length along a central axis is preferably set such that a maximum value is realized for a product of a quantity of effective light (the total quantity of light rays within a predetermined numerical aperture permitted as illumination light by the modulation device) and an illumination unevenness obtained by dividing the minimum value in the distribution of quantity of light rays within the predetermined numerical aperture by the maximum value.

By employing such a construction, the diffused light emitted from the light source can be utilized efficiently, and an image with little illumination unevenness can be obtained.

The light guiding member and optical unit of the present invention has the effect of efficiently uniformizing illumination unevenness at the emitting surface when diffused light is guided to an optical member having optical surfaces parallel to the optical axis, without requiring elongation of the light guiding member. The projector of the present invention has the effect of enabling illumination unevenness to be efficiently uniformized at the emitting surface of the optical unit and projecting an image free of illumination unevenness.

### BRIEF DESCRIPTION OF THE SEVERAL VIEWS OF THE DRAWINGS

FIG. 1 is a side view of a projector according to a first embodiment of the present invention.

FIG. 2 shows a front view of the illumination area of an optical unit according to the present embodiment used in the projector in FIG. 1.

FIG. 3 shows a side view of the illumination area of an optical unit according to the present embodiment used in the projector in FIG. 1.

FIG. 4 shows a perspective view of the illumination area of an optical unit according to the present embodiment used in the projector in FIG. 1.

FIG. 5 shows a front view of the illumination area of a comparative example of the optical unit in FIG. 2.

FIG. 6 shows a side view of the illumination area of a comparative example of the optical unit in FIG. 2.

FIG. 7 shows a perspective view of the illumination area of a comparative example of the optical unit in FIG. 2.

FIG. 8 is a graph comparing the light intensity distribution in the illumination area of the optical units in FIG. 2 through FIG. 4, and the optical units in FIG. 5 through FIG. 7.

FIG. 9 is a graph showing the relationship between the length of the second tapered rod section of the light guiding member used in the projector in FIG. 1, and the quantity of effective light.

FIG. 10 is a graph showing the relationship between the length of the second tapered rod section of the light guiding member used in the projector in FIG. 1, and the amount of illumination unevenness.

FIG. 11 is a graph showing the relationship between the length of the second tapered rod section of the light guiding member used in the projector in FIG. 1, and the product of the quantity of effective light and the illumination unevenness.

FIG. 12 shows a front view of the illumination area of a modification of the optical unit shown in FIG. 2 through FIG. 4.

FIG. 13 shows a side view of the illumination area of a modification of the optical unit shown in FIG. 2 through FIG. 4.

FIG. 14 shows a side view of another modification of the optical unit shown in FIG. 2 through FIG. 4.

FIG. 15 shows a side view of a modification of the projector in FIG. 1.

FIG. 16 is a graph showing the relationship between the length of the second tapered rod section of the light guiding member used in the projector in FIG. 1, and the quantity of effective light weighted by a coefficient α.

FIG. 17 is a graph showing the relationship between the length of the second tapered rod section of the light guiding member used in the projector in FIG. 1, and the product of the quantity of effective light and illumination unevenness weighted by the coefficient α.

FIG. 18 is an explanatory diagram describing the illumination unevenness produced when a tapered rod section and a parallel rod section abut, in a case where diffused illumination light emitted from a light source is guided by the tapered rod section to a transmissive LCD panel.

FIG. 19 is an explanatory diagram describing the illumination unevenness produced when a tapered rod section and a parallel rod section abut, in a case where a parallel rod section is provided at the emitting side of the tapered rod section.

FIG. 20 is a detail drawing of section P in FIG. 19.

### DETAILED DESCRIPTION OF THE INVENTION

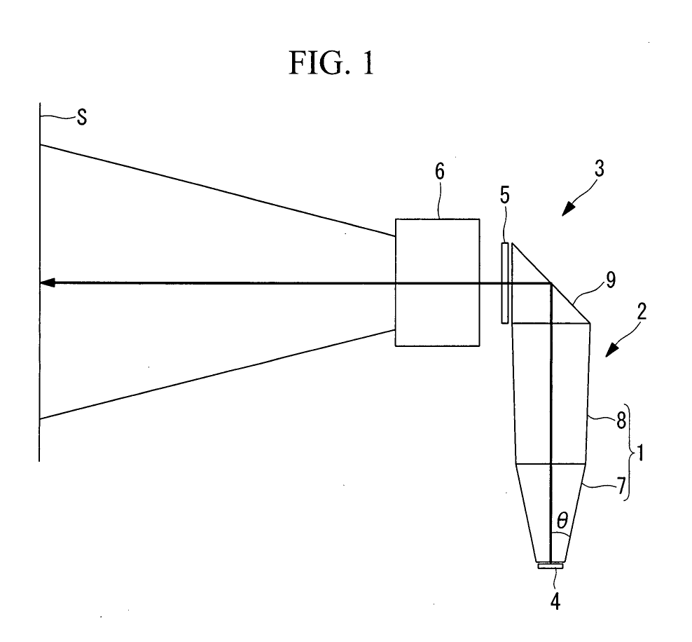

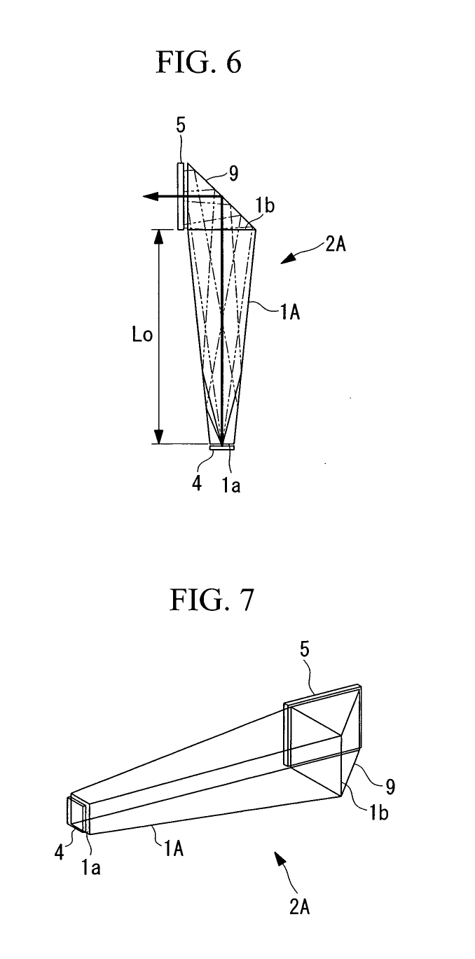

A light guiding member 1, an optical unit 2, and a projector 3 according to an embodiment of the present invention is described below with reference to FIG. 1 through FIG. 11.

As shown in FIG. 1, the projector 3 according to the present embodiment comprises a light source 4 which emits diffused light serving as illumination light, the optical unit 2 which guides the light from the light source 4, a transmissive LCD panel (modulation device) 5 which modulates the illumination light guided from the light source 4 by the optical unit 2, and a projection lens (projection optical device) 6 which projects the illumination light modulated by the transmissive LCD panel onto a screen S. For the sake of convenience, polarizing plates and the like are not shown in the drawings.

The light source 4 is an LED, for example.

As shown in FIG. 1, the optical unit 2 comprises the light guiding member 1 according to the present embodiment having two tapered rod sections 7 and 8, and an optical member comprising a triangular prism.

In this specification, as in reference documents 1 and 2, the term “taper angle” refers to the angle formed between a reflecting surface of the tapered rod and a central axis passing approximately through the center of the tapered rod from the incident surface to the emitting surface. For example, the taper angle of the tapered rod section 7 in FIG. 1 is the angle θ.

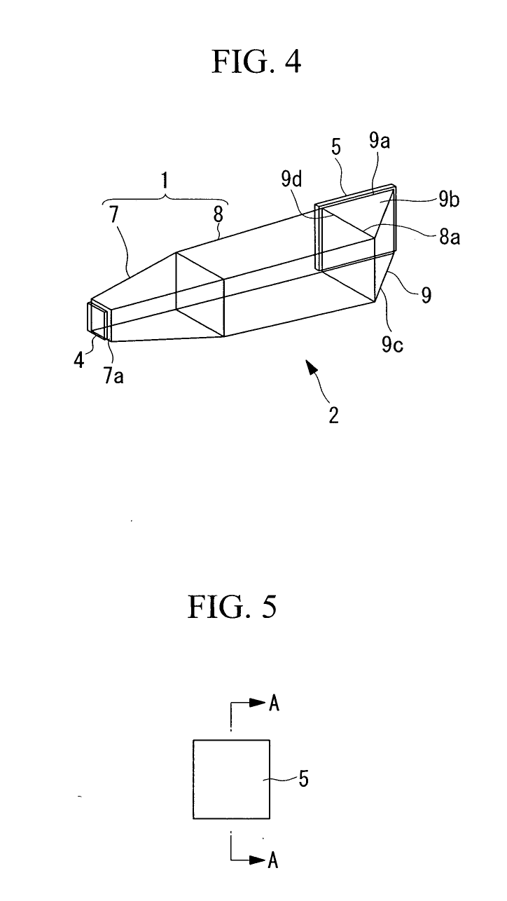

As shown in FIG. 4, the two tapered rod sections 7 and 8 that constitute the light guiding member 1 are formed to have a frustum shape with a rectangular transverse cross-section. The sides of the tapered rod sections 7 and 8 are flat. The tapered rod sections 7 and 8 are manufactured separately, and subsequently bonded together using an optical adhesive. By doing so, a light guiding member 1 can be formed which has minimal loss due to light leakage or reduced transmissivity.

The first tapered rod section 7 disposed on the light source 4 side and the second tapered rod section 8 disposed on the optical member 9 side are both shaped so as to broaden from the light source 4 side towards the optical member 9 side, each at a constant taper angle. The first tapered rod section 7 and the second tapered rod section 8 have the same shape and the same area at the junction between them, such that the external shapes thereof match up exactly when joined.

The taper angle of the first tapered rod section 7 is set to a larger angle than that of the second tapered rod section 8. Furthermore, the length of the first tapered rod section 7 in the longitudinal direction (the direction along the central axis) is less than the length of the second tapered rod section 8 in the longitudinal direction.

Accordingly, the area of both tapered rod sections 7 and 8 at the junction is greater than the average value of the area of the end surface (incident end) 7a at the light source 4 side of the first tapered rod section 7 and the area of the end surface (emitting end) 8a at the optical member 9 side of the second tapered rod section 8, but smaller than the area of the emitting end 8a.

Furthermore, the second tapered rod section 8, which constitutes part of the light guiding member 1, and the optical member 9 are bonded to each other using an optical adhesive. These members have the same area and same shape at the junction between them, and the external shapes thereof match up exactly. Furthermore, the emitting end surface 9a of the optical member 9 has approximately the same shape and the same area as the transmissive LCD panel 5.

The optical member 9 has a higher refractive index than the light guiding member 1. Accordingly, light reflected by the oblique surface of the optical member 9 is prevented from returning in the direction of the light guiding member 1.

Furthermore, there are optical surfaces which include triangle faces 9b and 9c, an incident end surface 9d, and the emitting end surface 9a. Here, optical surfaces which are parallel to the optical axis of the optical member 9 are the triangle faces 9b and 9c, which are on either side of the incident end surface 9d.

The operation of such a light guiding member 1, optical unit 2, and projector 3 according to the present embodiment is described below.

Diffused light emitted from the light source 4 enters the incident end 7a of the light guiding member 1, and is guided inside the light guiding member 1 from the first tapered rod section 7 to the second tapered rod section 8. Subsequently, light from the emitting end 8a of the light guiding member 1 is made incident onto the optical member 9, deflected 90° by a reflective surface of the optical member 9, and then emitted from the emitting end surface 9a. The diffused light is superposed on a video signal by transmission through the transmissive LCD panel 5, and then enlarged by the projection lens 6 and projected onto the screen S.

In this case, the diffused light made incident into the light guiding member 1 is reflected at the side surfaces of the first tapered rod section 7, and therefore imparted with greater directivity as the light is guided. Next, the diffused light made incident into the second tapered rod section 8 is reflected by the side surfaces thereof which are less steeply tapered than those of the first tapered rod section 7 and thereby imparted with even greater directivity, and is then made incident into the optical member 9.

Because the optical member 9 has optical surfaces 9a, 9b, 9c, and 9d which are parallel to the optical axis, part of the diffused light made incident is reflected by the optical surfaces 9a, 9b, 9c, and 9d. In the present embodiment, because the directivity of the diffused light is enhanced as the light is guided through the light guiding member 1 which presents progressively less steep taper angles, a lesser portion of the diffused light is reflected by the optical surfaces 9b and 9c in the optical member 9, and the light does not reflect back sharply from the optical surfaces 9b and 9c.

Accordingly, the illumination light emitted from the emitting end surface 9a of the optical member 9 becomes uniform light with little illumination unevenness. As a result, illumination unevenness produced in the image projected on the screen S via the transmissive LCD panel 5 and the projection lens 6 can be suppressed.

Furthermore, because according to the present embodiment the first tapered rod section 7, the second tapered rod section 8, and the optical member 9 are bonded together using an optical adhesive after being manufactured separately, the manufacturing process can be simplified and production costs reduced.

Moreover, because according to the present embodiment the two tapered rod sections 7 and 8 have the same area and the same shape at the junction between them, and the second tapered rod section 8 and the optical member 9 also have the same area and the same shape at the junction between them, no light is lost at the junctions when light is guided through the light guiding member 1. As a result, the utilization efficiency of the diffused light from the light source 4 can be improved and a bright image can be obtained.

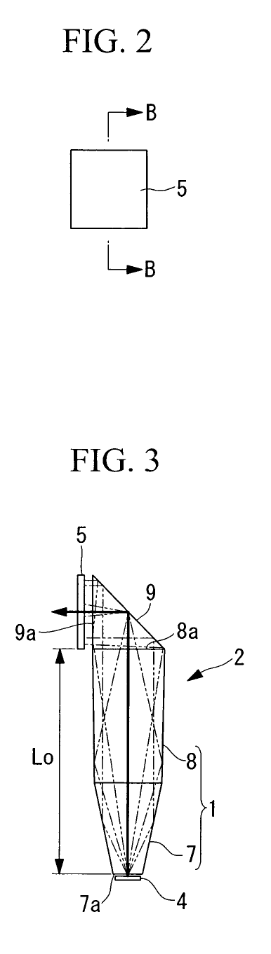

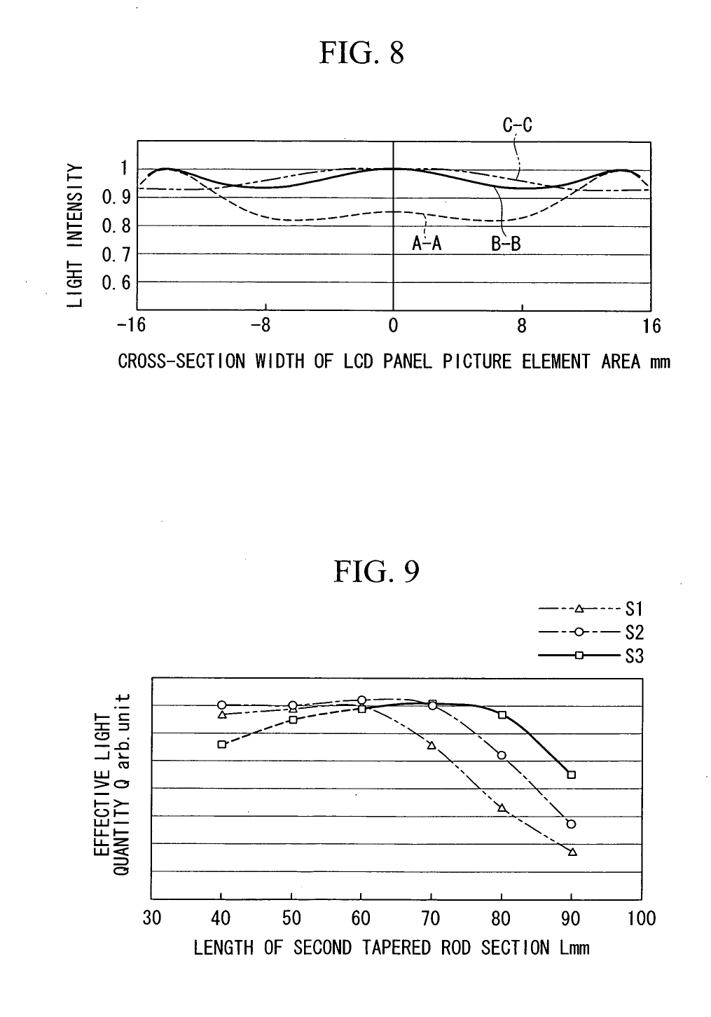

Here, FIG. 8 shows the results of a comparison between the uniformity of the light intensity at the transmissive LCD panel 5 for a case when a comparative example in the form of a light guiding member 1A as shown in FIG. 5 through FIG. 7 is used, and a case where the light guiding member 1 of the present embodiment is used. FIG. 8 shows the light intensity distribution of the light guiding member 1A shown in FIG. 5 through FIG. 7 at the cross-section A-A in FIG. 5, and the light intensity distribution of the light guiding member 1 of the present embodiment shown in FIG. 2 through FIG. 4 at the cross-section B-B in FIG. 2.

The light guiding member 1A shown in FIG. 5 through FIG. 7 is the same as the light guiding member 1 of the present embodiment, with the exception that the light guiding member 1A has a single taper angle from the incident end 1a to the emitting end 1b. That is to say, the light guiding member 1A in FIG. 5 through FIG. 7 have the same shape and area as the incident end 7a and the emitting end 8a of the light guiding member 1 of the present embodiment, and the light guiding member 1A also has the same length L₀ in the longitudinal direction as the light guiding member 1 of the present embodiment.

TABLE 1

| Item | Value |
|---|---|
| Light source light | ±60° |
| distribution angle | |
| Incident end of first tapered | 12.0 mm × 12.0 mm |
| rod section | |
| Emitting end of first tapered | 28.8 mm × 21.6 mm |
| rod section | |
| Length of first tapered rod | 40 mm |
| section | |
| Incident end of second | 28.8 mm × 21.6 mm |
| tapered rod section | |
| Emitting end of second | 32.0 mm × 24.0 mm |
| tapered rod section | |
| Length of second tapered rod | 60 mm |
| section | |
| Dimensions of triangular | 32.0 mm × 24.0 mm × 32.0 mm |
| prism | |
| LCD picture element area | 32.0 mm × 24.0 mm |
| Incident end of tapered rod | 12.0 mm × 12.0 mm |
| section (comparative example) | |
| Emitting end of tapered rod | 32.0 mm × 24.0 mm |
| section (comparative example) | |
| Length of tapered rod section | 100 mm |
| (comparative example) | |

As shown in FIG. 8, with an optical unit 2A using the light guiding member 1A shown in FIG. 5 through FIG. 7, illumination light is obtained which has low light intensity at the center of the picture element area of the transmissive LCD panel 5, and high light intensity at the periphery. In contrast, it is apparent from FIG. 8 that with the optical unit 2 using the light guiding member 1 according to the present embodiment, light intensity distribution remains within a narrow band across the entire picture element area of the transmissive LCD panel 5, and illumination unevenness is dramatically reduced.

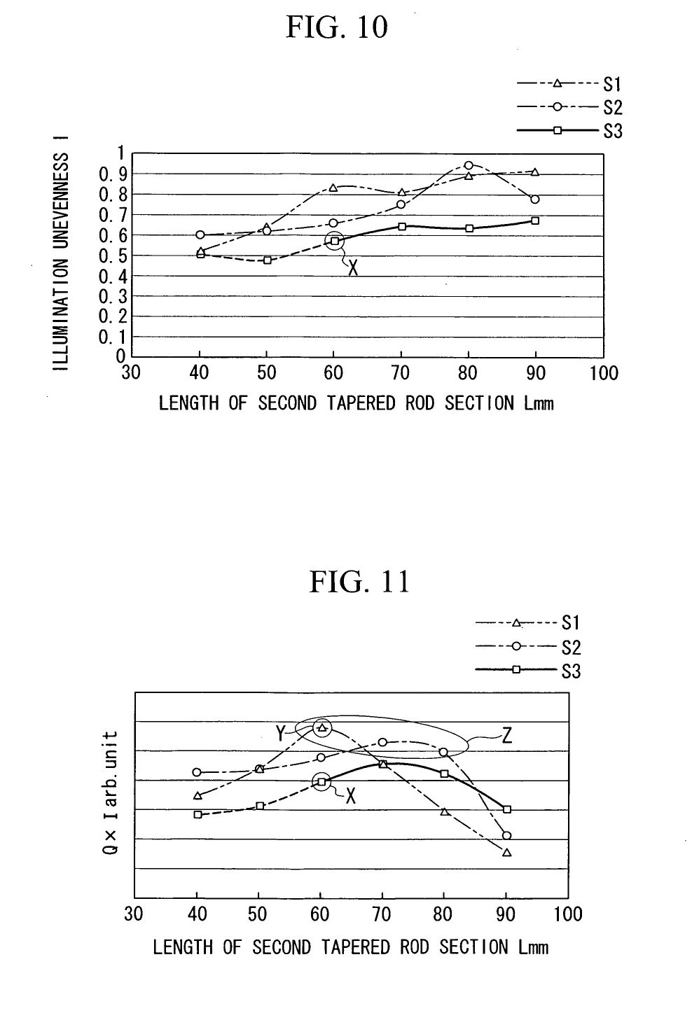

Next, the ratio between the lengths of the first tapered rod section 7 and the second tapered rod section 8 in the longitudinal direction is described with reference to FIG. 9 and FIG. 10.

FIG. 9 is a graph showing the relationship between the length L of the second tapered rod section 8 and the quantity of effective light Q for three samples S1 through S3 in which the area differs at the junction between the first tapered rod section 7 and the second tapered rod section 8. Here, the quantity of effective light Q refers to the total quantity of light rays within a predetermined numerical aperture (NA) permitted as illumination light by the transmissive LCD panel 5. The predetermined numerical aperture is 0.25, for example.

The sample S1 is the optical unit 2 of the present embodiment with the dimensions shown in Table 1, and the area at the junction is 28 mm×21.6 mm=604.8 mm². Furthermore, the sample S2 is the optical unit 2 with the same dimensions as the sample S1, with the exception that the area at the junction is 26 mm×20.4 mm=530.4 mm². The sample S3 is the optical unit 2 with the same dimensions as sample S1, with the exception that the area at the junction is 20 mm×16.8 mm=336 mm².

According to FIG. 9, the length L of the second tapered rod section 8 at which the maximum quantity of effective light Q was observed was different for each of the samples S1 through S3, but no significant difference in the maximum value of the quantity of effective light Q was apparent.

FIG. 10 is a graph showing the relationship between the length L of the second tapered rod section 8 and the illumination unevenness I, for the same samples S1 through S3. Here, the illumination unevenness I refers to a value obtained by dividing the minimum value in the distribution of quantity of light rays emitted from the emitting end 8a of the second tapered rod section 8 by the maximum value.

From FIG. 10, it is apparent that the illumination unevenness I is small when the area at the junction is large, and the length L of the second tapered rod section 8 is long. In particular, it is apparent that the illumination unevenness I is less than that of the optical unit of the comparative example (plot X) when the length L of the second tapered rod section 8 is longer than that of the first tapered rod section 7.

Furthermore, because commercialized products will require a large value for the quantity of effective light Q and a small value for the illumination unevenness I, as shown in FIG. 11, the dimensions of each component are preferably set such that the maximum value is obtained for Q×I. According to FIG. 11, the optical unit 2 of the present embodiment (plot Y) provides illumination light with the greatest efficiency, and the least illumination unevenness I. Furthermore, it is apparent that in some cases the value of Q×I is greatest when the area is large at the junction between the two tapered rod sections 7 and 8 (broken chain line Z).

In the present embodiment, the first tapered rod section 7 and the second tapered rod section 8 are manufactured separately and then bonded together using an optical adhesive, but may be formed as a single component instead.

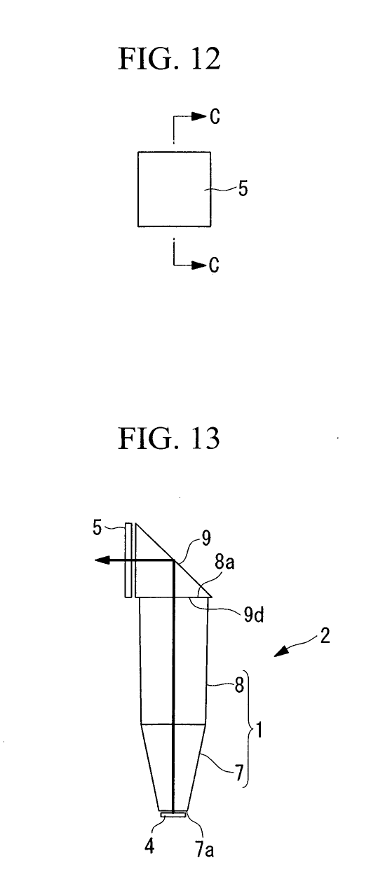

Furthermore, in the present embodiment, the emitting end 8a of the second tapered rod section 8 and the optical member 9 have the same shape and the same area at the junction between them, but alternatively, as shown in FIG. 12 and FIG. 13, the incident end 9d of the optical member 9 may be larger than the emitting end 8a of the second tapered rod section 8.

By employing such a construction, although the effect of improving the directivity of the emitted light is somewhat reduced when compared with the present embodiment, the illumination unevenness I can be uniformized even further. FIG. 8 also shows the light intensity distribution of the optical unit shown in FIG. 12 and FIG. 13 at the cross-section C-C in FIG. 12. It is apparent from FIG. 8 that a uniform light intensity distribution is attained across the entire picture element area of the transmissive LCD panel 5, within a similar light intensity band as the present embodiment. In addition, the light intensity distribution in this case shows high intensity at the center of the picture element area which reduces gradually towards the periphery, and this makes the illumination unevenness less visually apparent than in the case of the present embodiment. Accordingly, an image with even less illumination unevenness I can be projected by using the optical unit 2 shown in FIG. 12 and FIG. 13.

Furthermore, in the present embodiment, a triangular prism was used by way of example as the optical member 9 that connects to the light guiding member 1, but a polarizing beam splitter or dichroic prism may be used instead.

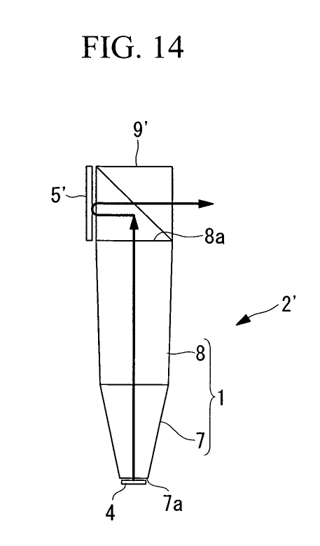

FIG. 14 shows an optical unit 2′ which uses a polarizing beam splitter as an optical member 9′. Furthermore, a reflective LCD panel 5′ is used as the modulation device. In this case also, by using the light guiding member 1 of the first embodiment, the uniformity of the illumination at the picture element area of the reflective LCD panel can be improved.

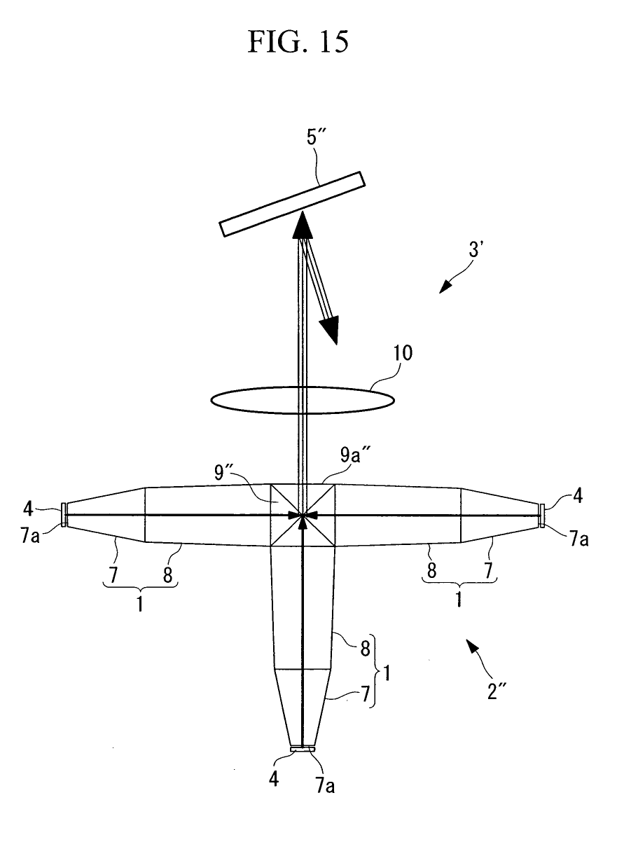

Furthermore, FIG. 15 shows a projector 3′ having an optical unit 2″ comprising three light guiding members 1 and a color combining prism (optical element: dichroic prism) 9″ which combines the diffused light guided via these light guiding members 1. A light source 4 is disposed at the incident end 7a of each of the light guiding members 1. Furthermore, a digital micromirror device (DMD) 5″ is used as the modulation device, and a lens 10 which directs light from the emitting end 9a″ of the color combining prism 9″ to produce an image on the picture element area of the DMD 5″ as a secondary light source image, is disposed between the color combining prism 9″ and the DMD 5″.

By employing such a construction, the diffused light emitted from each light source 4, in the process of being guided by the light guiding member 1, is converted to uniform illumination light with little illumination unevenness and high directivity before being made incident on the color combining prism 9″. Illumination light incident from three directions is then combined in the color combining prism 9″ and guided by the lens 10 to form an image on the picture element area of the DMD5″, and the resulting image is reflected by the DMD 5″ and thereby superposed on the image information and projected.

In this case, an image with low illumination unevenness I can be projected, as with the present embodiment.

Furthermore, in the present embodiment, an example was used in which the light guiding member 1 comprises two tapered rod sections 7 and 8, but three or more tapered rod sections may be used instead.

Moreover, the tapered rod sections 7 and 8 take the shape of a truncated pyramid with flat sides, but the present invention may also be applied to a light guiding member with tapered rod sections in the shape of a truncated circular cone.

Furthermore, suitable examples of the optical members 9, 9′, and 9″ include those in plate form such as a polarizing plate or a half wavelength plate in which the optical surfaces parallel to the optical axis are short, provided that the surfaces parallel to the optical axis are utilized as optical surfaces.

Moreover, in cases where uniform illumination is more important than the quantity of effective light, the quantity of effective light Q can be adjusted by a coefficient α to minimize its influence.

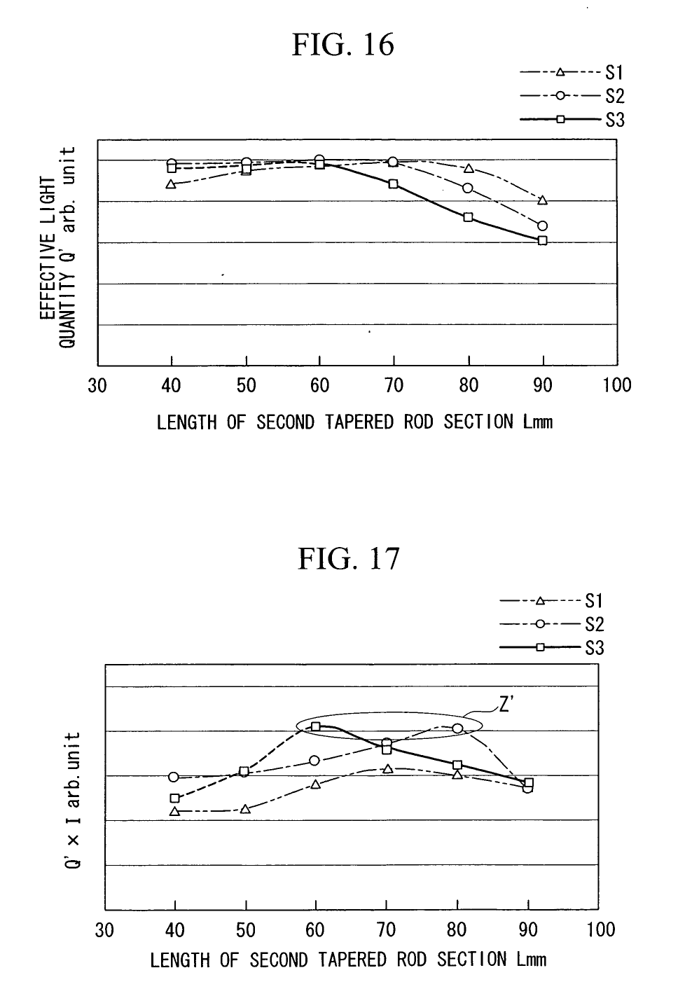

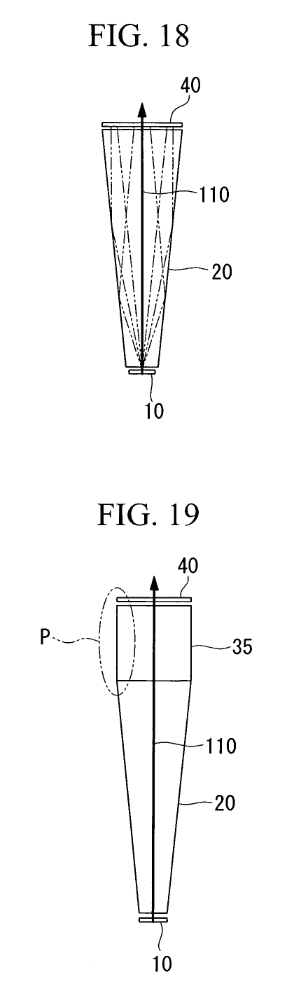

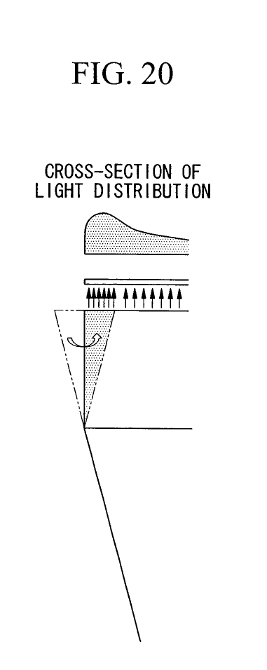

For example, the quantity of effective light can be adjusted using the formula; quantity of effective light Q′=Max−(Max−Q)/α. Here, Max is the peak value of the quantity of effective light Q. For example, FIG. 16 shows Q′ for a case where α=2.

FIG. 17 shows the relationship when Q′×I is determined using this quantity of effective light Q′. Accordingly, the optimal solution for Q′×I (the broken chain line Z′) for a case where uniform illumination is emphasized can be determined by using the coefficient α.

The value of the coefficient α is 0<α<1 for cases where the quantity of effective light is emphasized, and α>1 for cases where uniform illumination is emphasized. The value of the coefficient α can be adjusted freely. Furthermore, the weighting method is not limited to that described above.

What is claimed is:

1. A light guiding member which guides diffused light emitted from a light source to an optical member having optical surfaces parallel to the optical axis, wherein
a plurality of tapered rod sections which abut along a central axis direction passing substantially through the centers of an incident end disposed on the light source side and an emitting end disposed on the optical member side are provided between the incident end and the emitting end, and
each tapered rod section is shaped to widen gradually from the incident end side towards the emitting end side at a constant taper angle, and
a taper angle of each tapered rod section is set smaller than a taper angle of the adjacent tapered rod section on the incident end side.

2. A light guiding member according to claim 1, wherein the plurality of tapered rod sections are bonded to each other.

3. A light guiding member according to claim 1, comprising two tapered rod sections, such that a length along a central axis of a first tapered rod section disposed on an incident end side is shorter than a length along a central axis of a second tapered rod section disposed on an emitting end side.

4. A light guiding member according to claim 1, wherein surfaces constituting each tapered rod section are flat surfaces.

5. An optical unit comprising;
an optical member having optical surfaces parallel to an optical axis, and
a light guiding member which guides diffused light emitted from a light source to the optical member, wherein
the light guiding member comprises a plurality of tapered rod sections abutting in an optical axis direction between an incident end disposed on the light source side and an emitting end disposed on the optical member side, and
each tapered rod section is shaped to widen gradually from an incident end side towards an emitting end side at a constant taper angle, and
a taper angle of each tapered rod section is set smaller than a taper angle of the adjacent tapered rod section on the incident end side.

6. An optical unit according to claim 5, wherein the plurality of tapered rod sections and the optical member are bonded to each other.

7. An optical unit according to claim 5, wherein the optical member is any one of a triangular prism, a polarizing beam splitter, and a dichroic prism.

8. An optical unit according to claim 5, wherein the light guiding member comprises two tapered rod sections, and
a length along a central axis of a first tapered rod section disposed on an incident end side is shorter than a length along a central axis of a second tapered rod section disposed on an emitting end side.

9. An optical unit according to claim 5, wherein the emitting end of the light guiding member is approximately the same size and shape as the incident end of the optical member.

10. An optical unit according to claim 5, wherein the emitting end of the light guiding member is smaller than the incident end of the optical member.

11. An optical unit according to claim 5, wherein surfaces constituting the light guiding member are flat surfaces.

12. A projector comprising;
an optical unit,
a light source which emits diffused light serving as illumination light,
a modulation device which modulates an illumination light, which is a light emitted from an optical member of the optical unit onto which the illumination light from the light source is made incident, and
a projection optical device which projects the illumination light modulated by the modulation device onto a screen, and
the optical unit comprises;
an optical member having optical surfaces parallel to an optical axis, and
a light guiding member which guides diffused light emitted from a light source to the optical member, wherein
the light guiding member comprises a plurality of tapered rod sections abutting in an optical axis direction between an incident end disposed on the light source side and an emitting end disposed on the optical member side, and
each tapered rod section is shaped to widen gradually from an incident end side towards an emitting end side at a constant taper angle, and
a taper angle of each tapered rod section is set smaller than a taper angle of the adjacent tapered rod section on the incident end side.

13. A projector according to claim 12, wherein in each tapered rod section, a ratio of a taper angle to a length along a central axis is set such that a maximum value is realized for a product of a quantity of effective light (the total quantity of light rays within a predetermined numerical aperture permitted as illumination light by the modulation device) and an illumination unevenness obtained by dividing a minimum quantity of light rays within the predetermined numerical aperture by a maximum.
